(19) United States
(12) Patent Application Publication
(10) Pub. No.: US 2024/0004693 A1
(43) Pub. Date: Jan. 4, 2024

(54) BATCH WORKLOAD CONTROL BASED ON CAPACITY CONSUMPTION

(71) Applicant: BMC Software, Inc., Houston, TX (US)

(72) Inventor: Selby SHANLY, Toronto (CA)

(21) Appl. No.: 17/810,264

(22) Filed: Jun. 30, 2022

(51) Int. Cl. G06F 9/46; G06F 9/50; G06F 9/48

(52) U.S. Cl. CPC G06F 9/466; G06F 9/505; G06F 9/5038; G06F 9/4881

(57) ABSTRACT

Described techniques obtain processor consumption within a first time interval by a subset of processors of a plurality of processors of at least one computing device to update a rolling average of processor consumption of the subset of processors over a second time interval. By converting the rolling average to a consumption rate and determining a consumption ratio of the consumption rate to a base capacity provided by the subset of processors, described techniques may allocate a workload using the subset of processors, and based on the consumption ratio, to thereby control use of a priority capacity in processing the workload.

### TECHNICAL FIELD

This description relates to resource usage control for batch processing.

### BACKGROUND

Users of computing resources often prefer to consume such computing resources on an as-needed basis, while leaving many aspects of the deployment and management of the computing resources to a separate provider. For example, a business, school, government, or other entity may access cloud computing resources that are deployed remotely and accessed via a network, such as the public Internet. In other examples, such entities may deploy hardware platforms locally, while contracting with providers of such hardware platforms to obtain management, maintenance, and other relevant services. Still other examples may include a hybrid or combination of the above approaches.

In many cases, users may have multiple types of jobs to be performed in the context of the types of computing environments just referenced. For example, jobs may have different levels of priority or time-sensitivity, may take different amounts of time to complete, or may consume different quantities of computing resources within a given time period. Consequently, it may be difficult for users to match available types of computing resources with required types of jobs to be performed.

### SUMMARY

According to some general aspects, a computer program product may be tangibly embodied on a non-transitory computer-readable storage medium and may include instructions that when executed by at least one computing device, within a first time interval, the instructions may be configured to cause the at least one computing device to obtain processor consumption by a subset of processors of a plurality of processors of the at least one computing device, the subset of processors providing a base capacity and a priority capacity. When executed by the at least one computing device, the instructions may be configured to cause the at least one computing device to update, based on the processor consumption, a rolling average of processor consumption of the subset of processors over a second time interval and convert the rolling average to a consumption rate. When executed by the at least one computing device, the instructions may be configured to cause the at least one computing device to determine a consumption ratio of the consumption rate to the base capacity and allocate a workload of the at least one computing device using the subset of processors, based on the consumption ratio, to thereby control use of the priority capacity in processing the workload.

According to other general aspects, a computer-implemented method may perform the instructions of the computer program product. According to other general aspects, a system, such as a mainframe system or a distributed server system, may include at least one memory, including instructions, and at least one processor that is operably coupled to the at least one memory and that is arranged and configured to execute instructions that, when executed, cause the at least one processor to perform the instructions of the computer program product and/or the operations of the computer-implemented method.

The details of one or more implementations are set forth in the accompanying drawings and the description below. Other features will be apparent from the description and drawings, and from the claims.

### BRIEF DESCRIPTION OF THE DRAWINGS

FIG. 1 is a block diagram of a system for batch workload control based on capacity consumption.

FIG. 2 is a flowchart illustrating example operations of the system of FIG. 1.

FIG. 3 is a more detailed flowchart illustrating example operations of the system of FIG. 1.

FIG. 4 is a block diagram illustrating example batch workload control with constraint mapping in the system of FIG. 1.

### DETAILED DESCRIPTION

Described systems and techniques enable, for example, effective management and use of available computing resources. Described techniques ensure, for example, that time-critical transactional workloads are completed in a timely fashion, without using computing resources intended for the time-critical transactional workloads on workloads that are not as time-sensitive, such as batch workloads.

Many of the following example descriptions are provided in the context of mainframe 102 systems. In mainframe 102 systems, centralized processing is provided for, and linked to, many different workstations or terminals, e.g., in a corporate environment. For example, such mainframe 102 systems may provide core functionalities in healthcare, insurance, banking and finance, energy and oil and gas, manufacturing, or industrial settings, may store and process vast amounts of data for millions of customers.

Described implementations, however, are not limited to mainframe 102 environments. For example, as referenced above, multiple types of cloud environments, including public cloud, private cloud, or hybrid cloud environments may be used. Mainframe 102 environments may also be combined with, or used to implement, one or more types of such cloud environments.

In all such environments, it is possible for a user (e.g., entity) to obtain (e.g., to have allocated by a provider) a desired amount of computing resources (e.g., processing and/or memory resources) for performing anticipated workloads. For example, a user may attempt to obtain sufficient computing resources to ensure that any/all anticipated workloads may be performed at any given time.

Such an approach, however, may be inefficient, wasteful, and/or ineffective. For example, at any given time, a current workload may be significantly less than a total available capacity of computing resources. In other examples, a current workload may be unexpectedly large, and the allocated resources may be insufficient for completing the workload in a timely fashion.

Described techniques utilize a base hardware capacity (referred to herein as base capacity) that may be allocated or assigned on a long-term basis, and priority hardware capacity (referred to herein as priority capacity) designed to accommodate peak or spike workloads on a short-term or as-needed basis. Then, hardware monitoring and analysis are performed with respect to processors being used to provide the base and priority capacities, to directly determine a ratio or proportion of the base capacity being used by the processors.

In more specific examples, and as described in detail, below, processor-specific monitoring and analysis may be performed with respect to a subset of available processors to determine a current percentage of the base capacity being used, a current trend in usage, and/or a rate of increase (or decrease) of use of the base capacity. Then, batch workloads may be deferred, delayed, or otherwise managed to ensure that a total workload does not unnecessarily use the priority capacity.

In this way, the priority capacity may be reserved for its intended purpose of processing spikes and peaks in workloads. Consequently, a computing platform, such as a mainframe computing platform, may process workloads in an efficient, effective manner.

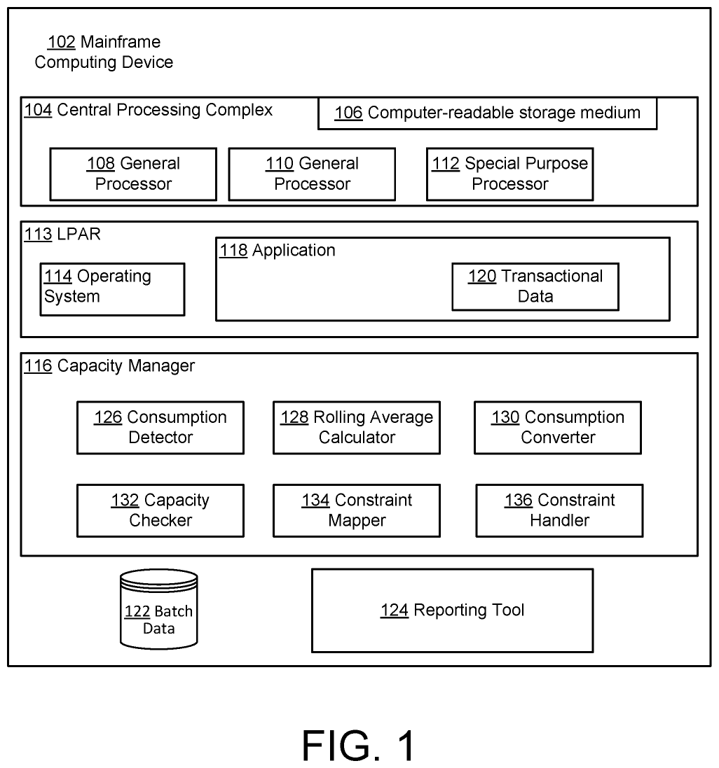

FIG. 1 is a block diagram of a system for batch workload control based on capacity consumption. In FIG. 1, a mainframe computing device 102, which may be referred to herein as a mainframe computer or mainframe, may be deployed by a business owner or organization, e.g., to support business functions. The mainframe 102 may support many different workstations or peripheral devices, or otherwise provide access and business functions to employees, administrators, customers, or other users.

The mainframe 102 is illustrated as including a central processing complex (CPC) 104. The CPC 104 may also be referred to as a central electronic complex (CEC), processor complex, or similar term(s) referring to a collection of hardware that enables operations of the mainframe 102.

As shown, the CPC 104 may include a computer-readable storage medium 106. The computer-readable storage medium 106 represents any suitable memory or memories (e.g., registers, main memory, or bulk/secondary memory) that may be used, e.g., to store instructions to be executed by at least one processor, represented in FIG. 1 by a plurality of processors that include general purpose processors illustrated as including a general processor 108 and a general processor 110, as well as a special purpose processor 112. For example, the computer-readable storage medium 106 may be used to store firmware governing operations of the CPC 104. The computer-readable storage medium 106 may also be used to store various types of data (e.g., business data, including customer data).

In addition to providing large quantities of processing and memory resources, the mainframe 102 should be understood to provide many other features and advantages, some of which are described herein by way of example. To assist in providing these features and advantages, the resources of the CPC 104 may be virtualized to provide many different sets of independent resources, e.g., by providing logical partitions (LPARS) or virtual machines. The example of FIG. 1 illustrates an LPAR 113, used to execute an operating system (OS) 114 that may be configured to, and optimized for, characteristics and functions of the mainframe 102. The OS 114 may, for example, provide task scheduling, application execution, and peripheral control for the LPAR 113. Put another way, the OS 114 enables use of the CPC 104 across many different use cases of the mainframe 102. Although the simplified example of FIG. 1 illustrates a single LPAR 113, it will be appreciated that the LPAR 113 may represent many different LPARs

The OS 114 may represent or include a suite or collection of system tools, services, and/or environments designed to support operations of the mainframe computing device 102. In many cases, such tools, services, and/or environments may evolve or be added over time. For example, the OS 114 may represent the z/OS® operating system, and may include, or utilize, a multiple virtual storage (MVS) system. In other examples, not specifically illustrated in FIG. 1, the OS 114 may provide a UNIX® operating environment known as z/OS Unix®. Other examples of mainframe operating systems may be used, as well.

In a mainframe environment, many different applications may leverage the central mainframe OS 114 to perform various tasks, or jobs, which may be collectively referred to as a workload. For example, multiple applications may continuously require jobs to be performed by a mainframe OS, so that it becomes necessary to schedule a coordinated execution of the various jobs by the mainframe OS 114.

A total capacity of the mainframe computing device 102 to process such workloads may be dictated by the properties of the CPC 104. For example, across multiple mainframes, the various processors 108, 110, 112 may operate at different speeds, or there may be differing numbers of processors in different CPCs. That is, although the simplified example of FIG. 1 illustrates the two general purpose processors 108, 110 and the special purpose processor 112, an actual implementation of the mainframe computing device 102 may have more than two processors (and types of processors) than shown.

As referenced above, a user (e.g., a business or other entity) of the mainframe computing device 102 may contract with a provider of the mainframe computing device 102 to obtain and use some or all of the capacity of the mainframe computing device 102. For example, the provider may provide the mainframe computing device 102 itself, as well as services related to the configuration, maintenance, and management of the mainframe computing device 102.

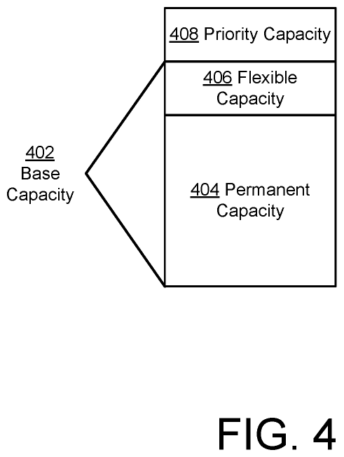

As also referenced above, the provider may also categorize or characterize the types of capacity provider to the user. For example, base capacity may refer to a defined portion or percentage of the total capacity of the mainframe computing device 102 that is consistently available and licensed to the user under the terms of the provider contract. Priority capacity may refer to reserved capacity that is provided to the user on a temporary or as-needed basis, e.g., to handle peak or spike workloads. Other types of capacity may also be used, some of which are referenced below, e.g., with respect to FIG. 4.

In FIG. 1, a capacity manager 116 may be configured to enable the user to use the provided and available capacity of the mainframe computing device 102 in an efficient, effective manner. For example, the capacity manager 116 may operate to ensure that the priority capacity is not used needlessly or for unintended purposes.

For example, as referenced above, the user may use the mainframe computing device 102 to execute various applications, represented in the simplified example of FIG. 1 as an application 118 executing in the LPAR 113. The application 118 may process various types of transactional data 120.

For example, the application 118 may relate to online sales, or other online transactions. Such transactions are often time-critical, because, e.g., an online consumer will be dissatisfied with any delay in an online transaction.

Such transactions may also have large spikes or peaks in workload(s). For example, if the application 118 relates to stock market transactions, then the application 118 may experience a spike in the transactional data 120 at a time of the opening of astock market.

Meanwhile, batch data 122 refers to data that is intended to be processed at defined times or intervals, and/or in defined quantities. For example, the batch data 122 may represent accumulated transactional data 120 that is intended to be processed together in a workload.

For example, the transactional data 120 may accumulate over the course of a day, or a week, or other time period. The accumulated transactional data 120 may then be processed as batch data 122, e.g., to determine average characteristics of the accumulated transactional data 120 over the relevant time period(s), or to otherwise aggregate, analyze, or report on the accumulated transactional data 120.

Further examples and characteristics of the transactional data 120 and the batch data 122 are known, and not described here in detail, except as may be necessary or helpful in understanding example operations of the capacity manager 116. In general, as may be understood from the above description, the batch data 122 may typically be processed using the base capacity of the CPC 104, while processing of the transactional data 120 may benefit from availability of the priority capacity.

In practice, however, it may be difficult or impossible for the user of the mainframe computing device 102 to ensure that the batch data 122 is processed using only the base capacity. For example, if large quantities of batch processing are implemented within a given time window, it may occur that some of the batch processing undesirably consumes a portion of the priority capacity within that time window. In other examples, substantial batch and transactional processing may occur simultaneously. Thus, in the above and other examples, a user of the mainframe computing device 102 may have a normal, typical, or expected processing load that may include one or both of batch and transactional processing at any given time, but that may (in total) deviate substantially in response to spikes in transaction processing. Described techniques enable reductions or other management of the batch processing to maintain the priority capacity for such transaction processing spikes. Consequently, it becomes possible to process all normal, typical, or expected processing loads using the base capacity, without consuming the priority capacity.

In some cases, a reporting tool 124 may be configured to monitor usage levels of the base capacity and the priority capacity. Typically, however, the reporting tool 124 may only be accessible by a provider of the mainframe computing device 102. Moreover, retrospective reporting of relative usages of the various capacity types may not be helpful to the user in planning and executing current and future workloads.

Consequently, in the example of FIG. 1, the capacity manager 116 is configured to infer a current usage of, and usage trends for, the base capacity. The capacity manager 116 may then constrain batch processing or other uses of the base capacity, so as to ensure that the priority capacity is not used needlessly or wastefully.

For example, the capacity manager 116 may include a consumption detector 126 that is configured to determine relevant usage and usage trends of a subset of processors of the plurality of processors within the CPC 104. For example, the base capacity and the priority capacity may only be defined with respect to the general processor 108 and the general processor 110, but not with respect to the special purpose processor 112.

For example, the general processor 108 and the general processor 110 may refer to general purpose processors that are allocated for, and capable of, processing any of the transactional data 120 and batch data 122. The special purpose processor 112 may be allocated for performing specific types of processing, such as processing database data, or for processing specific types of code (e.g., Java).

In example implementations, the reporting tool 124 may be configured to characterize capacity usage of the CPC 104 based on usage of the general processor 108 and the general processor 110, or based on some other subset of processors of the CPC 104. For example, the consumption detector 126 may be configured to query the CPC 104 (e.g., firmware of the CPC 104) and determine current usage levels of the relevant subset of processors.

As described in detail below, consumption levels may be detected and characterized using a number of different techniques. For example, the consumption detector 126 may determine a number of processor cycles, e.g., measured in microseconds of processor usage, across all of the processors of the CPC 104 and within a first-time interval (e.g., every 10 seconds, or other suitable time interval). The consumption detector 126 may extract or otherwise determine usage of the general processor of 108 and the general processor 110 from within or among the CPC 104 consumption data.

As each increment out of consumption data is detected at the first-time interval (e.g., every ten seconds), a rolling average calculator 128 may be configured to update a consumption rolling average calculated across a second, longer time interval (e.g., every five minutes, ten minutes, or fifteen minutes). For example, the second-time interval may be selected to match or correspond to a reporting time interval used by the reporting tool 124.

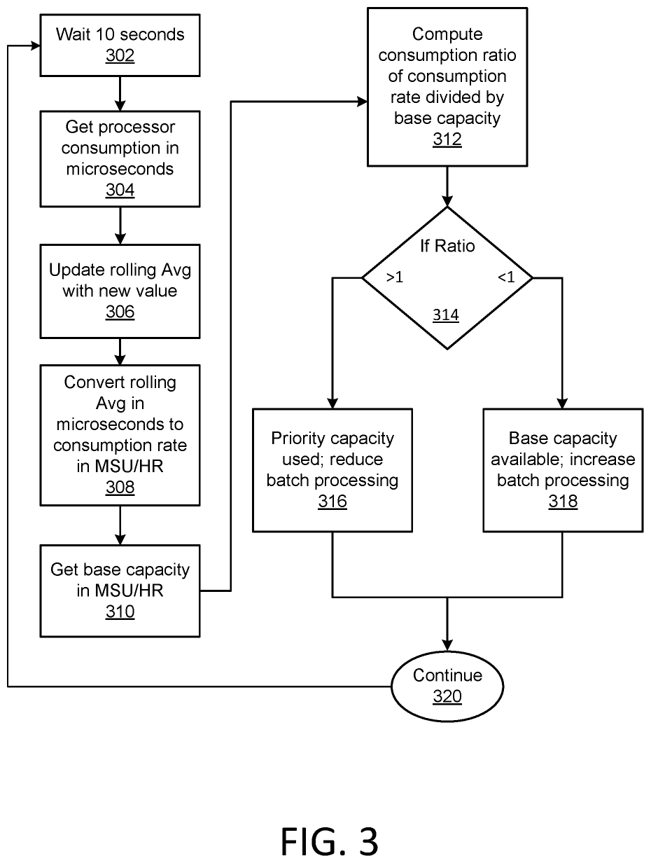

Operations of the rolling average calculator 128 are described in more detail below, e.g., with respect to FIG. 3. In general, however, it may be appreciated that calculation of the rolling average of consumption data provides insight into both the usage and usage trends of the relevant subset of processors of the plurality of processors of the CPC 104. Moreover, calculating the rolling average of consumption data across a second time interval that is matched with a reporting interval of the reporting tool 124 enables a valid comparison with metrics used by the reporting tool 124 to differentiate priority capacity from base capacity.

In order to further enable such comparisons, a consumption converter 130 may be configured to convert the rolling average of consumption data from processor-specific consumption data to a standardized consumption metric. For example, the reporting tool 124 may use a standardized consumption metric that applies to many different mainframe computing devices, or types of mainframe computing devices. The consumption converter 130 may be configured to interact with the OS 114 or otherwise determine a suitable conversion factor for converting the processor-specific consumption data of the CPC 104 to a standardized consumption metric.

For example, the general processor 108 and the general processor 110 may both operate at a certain processing speed, e.g., measured in cycles per second. This processing speed may be different from various other processors (e.g., processors in other mainframe computing devices). Consequently, a quantity of work (e.g., calculations) performed by the CPC 104 in a given time period may be more or less than a quantity of work performed in the same time period by another processor.

The consumption converter 130 may thus use a standardized metric, such as a service unit, that represents a quantity of work performed in a unit of time. In the following examples, the consumption converter 130 is described as characterizing consumption data as millions of service units per hour, referred to herein as MSUs/hour. Other suitable metrics may be used, as well.

Then, a capacity checker 132 may be configured to compare the standardized consumption rolling average across the second time interval to the base capacity, e.g., as a ratio, proportion, or percentage. For example, the capacity checker 132 may determine that the current standardized consumption rolling average is at x % of the known base capacity, may determine whether a trend of the standardized consumption rolling average is higher or lower, and/or may determine a rate of the trend higher/lower.

A constraint mapper 134 may then map the determined consumption/base capacity ratio, consumption trend, and/or consumption trend rate to corresponding types or levels of constraints, e.g., on batch processing of the batch data 122. For example, in some simplified examples, such as shown in FIG. 3, the constraint mapper 134 may simply increase or decrease levels of batch processing when the consumption/base capacity ratio is greater than one or less than or equal to one, respectively.

In other examples, as described in more detail below with respect to FIG. 4, one or more capacity thresholds may be set with respect to the consumption/base capacity ratio. Then, a corresponding type and/or extent of constraint(s) may be determined from a current value of the consumption/base capacity ratio, as compared to the capacity thresholds.

For example, capacity thresholds may be set at 70%, 80%, 90%, 100%, or 110% of the total base capacity. At each level of the capacity thresholds, the constraint mapper 134 may determine a corresponding constraint. For example, the constraint mapper 134 may determine a volume of batch data 122 to be deferred, and/or a length of time of such a deferral. In other examples, a constraint may include limiting processing resources devoted or available to some or all batch processing of the batch data 122.

A constraint handler 136 may then be configured to implement the constraints determined by the constraint mapper 134. For example, the constraint handler 136 may delay submission of batch processing jobs to the OS 114 or may communicate with the OS 114 to reduce system resources available to the batch processing.

The constraint handler 136 may be configured to adjust such constraints based on ongoing mapping operations of the constraint mapper 134. For example, the constraint handler 136 may operate to provide dynamic constraint adjustments to gradually increase or decrease batch processing constraints over a period of time and at a rate that corresponds to consumption trends determined by the capacity checker 132.

In some cases, batch processing jobs may be lengthy, and, once started, may be difficult to interrupt. If such batch jobs are initiated but intrude upon the priority capacity in an unintended fashion, then large quantities of the priority capacity may be used wastefully.

In FIG. 1, however, as just described, the capacity manager 116 may be configured to proactively adjust constraints in order to ensure that desired levels of base/priority capacity are used. For example, by determining that consumption rates are increasing prior to a base capacity threshold being reached, constraints may be enacted to ensure that a lengthy batch processing job (which might otherwise cause extensive, unintended use of priority capacity) is not initiated.

Likewise, by determining that consumption rates are decreasing, constraints may be gradually decreased as well, so that use of the base capacity can be closely calibrated to actual needs of the user. Accordingly, the capacity manager 116 avoids overcompensating for potential or actual use of the priority capacity, ensures that the base capacity is used effectively, and ensures that the priority capacity is maintained for its intended purpose of processing high-priority workloads (such as processing the transactional data 120).

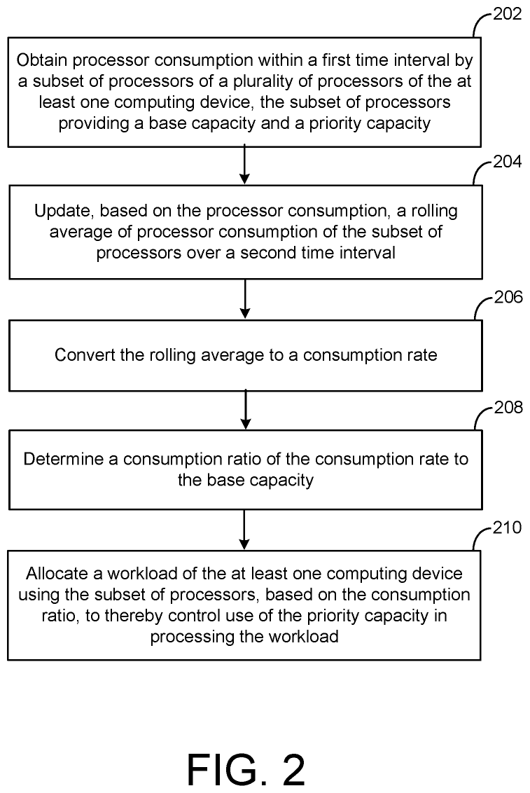

FIG. 2 is a flowchart illustrating example operations of the system of FIG. 1. In the example of FIG. 2, operations 202-210 are illustrated as separate, sequential operations. In various implementations, the operations 202-210 may include sub-operations, may be performed in a different order, may include alternative or additional operations, or may omit one or more operations. Further, in all such implementations, included operations may be performed in an iterative, looped, nested, or branched fashion.

In the example of FIG. 2, processor consumption may be obtained within a first time interval by a subset of processors of a plurality of processors of the at least one computing device, the subset of processors providing a base capacity and a priority capacity (202). For example, the consumption detector 126 may communicate with the CPC 104 to determine processor usage, e.g., measured in microseconds, of the general processor 108 and the general processor 110. For example, the consumption detector 126 may obtain the processor consumption every 5 seconds, 10 seconds, 20 seconds, or other suitable time interval. For example, as described in more detail below, with respect to FIG. 3, the consumption detector 126 may issue a particular instruction or set of instructions to the OS 114 to obtain processor consumption of the general processor 108 and the general processor 110, but not the special purpose processor 112.

Based on the processor consumption, a rolling average of processor consumption of the subset of processors over a second time interval may be updated (204). For example, the rolling average calculator 128 may be configured to use a second time interval that corresponds to a reporting interval of the reporting tool 124 (e.g., five minutes, ten minutes, or fifteen minutes). The rolling average may be updated using the measurement obtained over the first time interval.

The rolling average may be converted to a consumption rate (206). For example, the consumption converter 130 may be configured to convert the rolling average into a standardized consumption metric that is not particular to characteristics of the general processor 108 or the general processor 110. For example, as described in more detail below, with respect to FIG. 3, the consumption converter 130 may interface with the OS 114 to determine a conversion factor for converting a consumption metric used by the consumption detector 126 into a standardized consumption rate, such as MSUs/hour.

A consumption ratio of the consumption rate to the base capacity may be determined (208). For example, the capacity checker 132 may determine a quantity of the base capacity. For example, the base capacity may be chosen and stored by a user of the mainframe computing device 102, e.g., at a time of configuration of the mainframe computing device 102.

A workload of the at least one computing device using the subset of processors may be allocated, based on the consumption ratio, to thereby control use of the priority capacity in processing the workload (210). For example, the constraint handler 136 may place various types of constraints on specific workloads or types of workloads. For example, such constraints may be placed on batch workloads by delaying a start(s) of such workloads, or by providing fewer system resources for executing such workloads (so that the workloads take longer to complete). As described, a type or extent of such constraints, as well as a determination of whether and when to initiate such constraints, may be determined by the constraint mapper 134 from the consumption ratio and related information.

FIG. 3 is a more detailed flowchart illustrating example operations of the system of FIG. 1. In the example of FIG. 3, the process begins by waiting 10 seconds as the first time interval of FIG. 2 (302).

Then, processor consumption in microseconds may be obtained (304). For example, the consumption detector 126 may query the CPC 104 to obtain running usage totals in microseconds for each processor of every type within the CPC 104. The consumption detector 126 may determine net usage over the defined period of time (e.g., 10 seconds) by subtracting one set of results limited to general purpose processors from those in another set of results, omitting or removing consumption results for remaining processors (e.g., special purpose processors). In other examples, the LPAR 113 and/or the OS 114 may be used to determine processor consumption.

For example, the consumption detector 126 may determine a number of processor cycles used by all LPARs being executed by the CPC 104 (including the LPAR 113), and then adding up the obtained number of processor cycles to the microsecond. Since the results are unlikely to be obtained for the exact time interval being used, the consumption detector 126 may normalize the results for the interval.

Put another way, the processor consumption in microseconds of processor cycles used within the 10-second interval may be added to previously obtained processor consumption in microseconds of processor cycles during preceding increments of the 10-second time interval. Processor consumption may then be normalized across the preceding increments of the 10-second interval and the current 10-second interval to obtain the rolling average over the second time interval 306.

That is, in FIG. 3, the normalized consumption within 10 seconds may then be used to update a rolling average calculated across the second time interval (306). Then, the rolling average in microseconds may be converted to a consumption rate measured in MSUs/hour (308).

For example, the consumption converter 130 may obtain and utilize a suitable conversion factor and/or scaling factor from the OS 114 for the particular mainframe computing device 102, e.g., from a control block of the OS 114. The control block may be accessed by following pointers in other OS 114 control blocks, and a formula for conversion from CPU time to MSUs/hour (using the two conversion/scaling factors) may then be used.

The base capacity may be determined in the same units used to characterize the consumption rate (310), e.g., MSUs/hour. For example, the capacity checker 132 may determine the base capacity, as described above. The base capacity may also be determined and set at an earlier time, e.g., prior to initiation of the operations of FIG. 3.

A consumption ratio of the determined consumption rate to the base capacity may then be determined (312), e.g., by the capacity checker 132. In the simplified example of FIG. 3, if the resulting ratio is greater than 1 (314), then the capacity checker 132 may determine that the priority capacity is being used and may reduce batch processing (316) by issuing an instruction to the constraint handler 136 to increase constraints. If the resulting ratio is less than 1 (314), then the capacity checker 132 may determine that base capacity is available and may increase batch processing (318) by issuing an instruction to the constraint handler 136 to decrease constraints. In either case, the process may then continue (320).

As described above, however, more detailed constraint handling may also be implemented. For example, FIG. 4 is a block diagram illustrating example batch workload control with constraint mapping in the system of FIG. 1.

In the example of FIG. 4, a total base capacity 402 is illustrated as including permanent capacity 404 and flexible capacity 406. For example, in some cases, a user of the mainframe computing device 102 may deploy one or more additional mainframe computing devices, e.g., in separate physical locations (e.g., in data centers in different cities). Then, flexible capacity 406 may be provided to the user and may be allocated among the different locations, e.g., for purposes of flexibility in resource usage, for avoiding peak resource usage time(s), and/or for disaster recovery purposes, or other uses.

The techniques described above with respect to FIGS. 1-3 may be used to impose constraints on batch processing performed using the base capacity 402, so as to preserve effective use of the priority capacity 408. For example, the user of the mainframe computing device 102 may be enabled to configure the constraint mapper 134 with threshold percentage values that map the consumption ratio (e.g., rolling interval percentage of base capacity 402) to one of a number of defined capacity levels. The capacity levels may then be used to map to corresponding constraints to be applied automatically to designated subsets of upcoming batch workloads.

Thus, for example, as the consumption ratio varies, a capacity level will change, and the constraints applied to the batch workload will therefore also change. For example, constraints on batch workloads may increase as the consumption ratio increases. When the consumption ratio is below the lowest defined threshold percentage, constraints on batch workload processing may be removed.

In more specific examples, values for the threshold consumption ratio values that map to the capacity levels may be user-defined at 80%, 85%, 90%, 95%, 100%, or any suitable percentage. The user may change these values within a defined range, e.g., from as low as 20% to 150% of the base capacity. Values higher than 100% indicate a willingness of the user to utilize at least some priority capacity for batch workload processing.

Multiple capacity levels allow constraints to be phased in and out gradually. As referenced above, constraints may include delaying a batch workload(s) to a later time(s), changing access to processor resources for particular batch workload(s), and/or limiting a number of jobs in execution for batch workload(s).

Accordingly, use of consistently available priority capacity may be avoided in processing large batch workloads, which may otherwise increase usage of a mainframe enough to start using some or all of the priority capacity, at additional cost for the user. For example, usage of capacity in excess of the base capacity over any 15-minute interval may be billed by a provider of the mainframe computing device 102, as determined by the reporting tool 124.

Described techniques enable preservation of the priority capacity for handling, e.g., online transaction load spikes, not batch workloads. Processor consumption of designated batch workloads may be automatically reduced when there is overall heavy processor demand, resulting in more efficient and effective use of the mainframe computing device 102.

Implementations of the various techniques described herein may be implemented in digital electronic circuitry, or in computer hardware, firmware, software, or in combinations of them. Implementations may be implemented as a computer program product, i.e., a computer program tangibly embodied in an information carrier (e.g., in a non-transitory computer readable medium), e.g., in a machine-readable storage device, for execution by, or to control the operation of, data processing apparatus, e.g., a programmable processor, a computer, a server, a mainframe computer, multiple computers, or other kind(s) of digital computer(s). A computer program, such as the computer program(s) described above, can be written in any form of programming language, including compiled or interpreted languages, and can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

Method steps may be performed by one or more programmable processors executing a computer program to perform functions by operating on input data and generating output. Method steps also may be performed by, and an apparatus may be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. Elements of a computer may include at least one processor for executing instructions and one or more memory devices for storing instructions and data. Generally, a computer also may include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory may be supplemented by or incorporated in special purpose logic circuitry.

To provide for interaction with a user, implementations may be implemented on a computer having a display device, e.g., a cathode ray tube (CRT) or liquid crystal display (LCD) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Implementations may be implemented in a computing system that includes a back-end component, e.g., as a data server, or that includes a middleware component, e.g., an application server, or that includes a front-end component, e.g., a client computer having a graphical user interface or a Web browser through which a user can interact with an implementation, or any combination of such back-end, middleware, or front-end components. Components may be interconnected by any form or medium of digital data communication, e.g., a communication network. Examples of communication networks include a local area network (LAN) and a wide area network (WAN), e.g., the Internet.

While certain features of the described implementations have been illustrated as described herein, many modifications, substitutions, changes, and equivalents will now occur to those skilled in the art. It is, therefore, to be understood that the appended claims are intended to cover all such modifications and changes as fall within the scope of the embodiments.

What is claimed is:

1. A computer program product, the computer program product being tangibly embodied on a non-transitory computer-readable storage medium and comprising instructions that, when executed by at least one computing device, are configured to cause the at least one computing device to:
obtain processor consumption within a first time interval by a subset of processors of a plurality of processors of the at least one computing device, the subset of processors providing a base capacity and a priority capacity;
update, based on the processor consumption, a rolling average of processor consumption of the subset of processors over a second time interval;
convert the rolling average to a consumption rate;
determine a consumption ratio of the consumption rate to the base capacity; and
allocate a workload of the at least one computing device using the subset of processors, based on the consumption ratio, to thereby control use of the priority capacity in processing the workload.

2. The computer program product of claim 1, wherein the at least one computing device includes at least one mainframe computing device, and the subset of processors includes general purpose processors of a central processing complex of the at least one mainframe computing device, and remaining processors of the central processing complex include at least one special purpose processor.

3. The computer program product of claim 2, wherein the instructions are further configured to cause the at least one computing device to:
determine total processor consumption of the central processing complex; and
extract the processor consumption by the general purpose processors from the total processor consumption.

4. The computer program product of claim 1, wherein the instructions are further configured to cause the at least one computing device to:
determine the processor consumption in microseconds of processor cycles used within the first time interval.

5. The computer program product of claim 4, wherein the instructions are further configured to cause the at least one computing device to:
add the processor consumption in microseconds of processor cycles used within the first time interval to previously-obtained processor consumption in microseconds of processor cycles during preceding increments of the first time interval; and
normalize processor consumption across the preceding increments of the first time interval and the first time interval to obtain the rolling average over the second time interval.

6. The computer program product of claim 1, wherein the instructions are further configured to cause the at least one computing device to:
convert the rolling average to a consumption rate measured in millions of service units (MSUs) per hour.

7. The computer program product of claim 1, wherein the workload includes transactional jobs and batch jobs, and wherein the instructions are further configured to cause the at least one computing device to:
allocate the workload by constraining the batch jobs to preserve the priority capacity for use by the transactional jobs.

8. The computer program product of claim 7, wherein the instructions are further configured to cause the at least one computing device to:
schedule the batch jobs at a later time and/or with fewer resources to preserve the priority capacity for use by the transactional jobs, based on the consumption ratio.

9. The computer program product of claim 7, wherein the instructions are further configured to cause the at least one computing device to:
map the consumption ratio to a corresponding constraint level of a plurality of constraint levels; and
constrain the batch jobs based on the corresponding constraint level.

10. The computer program product of claim 1, wherein the subset of processors includes general purpose processors of a central processing complex (CPC) of at least one mainframe computing device, and remaining processors of the central processing complex include at least one special purpose processor, and further wherein the instructions are further configured to cause the at least one computing device to:
query the CPC to determine the processor consumption.

11. A computer-implemented method, the method comprising:
obtaining processor consumption within a first time interval by a subset of processors of a plurality of processors of at least one computing device, the subset of processors providing a base capacity and a priority capacity;
updating, based on the processor consumption, a rolling average of processor consumption of the subset of processors over a second time interval;
converting the rolling average to a consumption rate;
determining a consumption ratio of the consumption rate to the base capacity; and
allocating a workload of the at least one computing device using the subset of processors, based on the consumption ratio, to thereby control use of the priority capacity in processing the workload.

12. The method of claim 11, wherein the subset of processors includes general purpose processors of a central processing complex of a mainframe system, and remaining processors of the central processing complex include at least one special purpose processor.

13. The method of claim 12, further comprising:
determining total processor consumption of the central processing complex; and
extracting the processor consumption by the general purpose processors from the total processor consumption.

14. The method of claim 11, wherein the workload includes transactional jobs and batch jobs, the method further comprising:
allocating the workload by constraining the batch jobs to preserve the priority capacity for use by the transactional jobs.

15. The method of claim 14, further comprising:
scheduling the batch jobs at a later time and/or with fewer resources to preserve the priority capacity for use by the transactional jobs, based on the consumption ratio.

16. The method of claim 14, further comprising:
mapping the consumption ratio to a corresponding constraint level of a plurality of constraint levels; and
constraining the batch jobs based on the corresponding constraint level.

17. The method of claim 11, wherein the subset of processors includes general purpose processors of a central processing complex (CPC) of at least one mainframe computing device, and remaining processors of the central processing complex include at least one special purpose processor, the method further comprising:
querying the CPC to determine the processor consumption.

18. A mainframe system comprising:
at least one memory including instructions; and
at least one processor that is operably coupled to the at least one memory and that is arranged and configured to execute instructions that, when executed, cause the at least one processor to
obtain processor consumption within a first time interval by a subset of processors of a plurality of processors of the mainframe system, the subset of processors providing a base capacity and a priority capacity;
update, based on the processor consumption, a rolling average of processor consumption of the subset of processors over a second time interval;
convert the rolling average to a consumption rate;
determine a consumption ratio of the consumption rate to the base capacity; and
allocate a workload of the mainframe system using the subset of processors, based on the consumption ratio, to thereby control use of the priority capacity in processing the workload.

19. The system of claim 18, wherein the workload includes transactional jobs and batch jobs, and wherein the instructions are further configured to cause the at least one processor to:
allocate the workload by constraining the batch jobs to preserve the priority capacity for use by the transactional jobs.

20. The system of claim 19, wherein the instructions are further configured to cause the at least one processor to:
map the consumption ratio to a corresponding constraint level of a plurality of constraint levels; and
constrain the batch jobs based on the corresponding constraint level.
